(19) United States
(12) Patent Application Publication
(10) Pub. No.: US 2019/0152246 A1
(43) Pub. Date: May 23, 2019

(54) INORGANIC PIGMENT PRINTING METHOD

(71) Applicant: MIMAKI ENGINEERING CO., LTD., NAGANO (JP)

(72) Inventors: Akifumi SEKI, NAGANO (JP); Masaru OHNISHI, NAGANO (JP)

(73) Assignee: MIMAKI ENGINEERING CO., LTD., NAGANO (JP)

(21) Appl. No.: 15/505,072

(22) PCT Filed: Aug. 21, 2015
(86) PCT No.: PCT/JP2015/073494

§ 371 Date: Feb. 18, 2017

(30) Foreign Application Priority Data
Aug. 21, 2014 (JP) 2014-168863

(51) Int. Cl. B41M 5/00; B41M 7/00

(52) U.S. Cl. CPC B41M 5/0011; C09D 11/322; B41M 7/009; B41M 5/0023

(57) ABSTRACT

[Task] To provide an inorganic pigment printing method capable of performing printing on a medium with an inorganic pigment, without performing a pretreatment process of adhering a pretreatment agent for preventing bleeding to the medium.

[Solution] An inorganic pigment printing method of performing printing on a medium with an inorganic pigment is characterized by including: a resin fixing process (S61) of fixing an ultraviolet curing resin curable by being irradiated with ultraviolet light, to the medium, by performing printing on the medium by a UV inkjet printer configured to eject the ultraviolet curing resin and radiate ultraviolet light onto the ejected ultraviolet curing resin; and a pigment fixing process (S63) of fixing the inorganic pigment to the medium while removing the ultraviolet curing resin by burning in a state where the inorganic pigment has been fixed to the ultraviolet curing resin fixed to the medium by the resin fixing process.

### TECHNICAL FIELD

The present invention relates to an inorganic pigment printing method of performing printing on media with an inorganic pigment.

### BACKGROUND ART

In the related art, as an inorganic pigment printing method of performing printing on a medium with an inorganic pigment, a method including a pretreatment process of adhering a pretreatment agent composed of glass flit and a water-soluble polymer for preventing bleeding of ink containing an inorganic pigment, to a medium, an ink fixing process of fixing the ink to the medium by performing printing on the medium by an inkjet printer after the pretreatment process, and a pigment fixing process of fixing the inorganic pigment to the medium while removing the ink fixed to the medium by the ink fixing process by burning is known (see PTLs 1 and 2).

### CITATION LIST

### Patent Literature

PTL 1: Japanese Patent No. 4524091

PTL 2: Japanese Patent No. 4524095

### SUMMARY OF INVENTION

### Technical Problem

However, the inorganic pigment printing method of the related art has a problem in which the pretreatment process of adhering the pretreatment agent for preventing bleeding to media is essential.

Therefore, an object of the present invention is to provide an inorganic pigment printing method capable of performing printing on a medium with an inorganic pigment, without performing a pretreatment process of adhering a pretreatment agent for preventing bleeding to the medium.

### Solution to Problem

An inorganic pigment printing method of the present invention is an inorganic pigment printing method of performing printing on a medium with an inorganic pigment, and is characterized by including: a resin fixing process of fixing an ultraviolet curing resin curable by being irradiated with ultraviolet light, to the medium, by a UV inkjet printer configured to eject the ultraviolet curing resin and radiate ultraviolet light onto the ejected ultraviolet curing resin; and a pigment fixing process of fixing the inorganic pigment to the medium while removing the ultraviolet curing resin by burning in a state where the inorganic pigment has been fixed to the ultraviolet curing resin fixed to the medium by the resin fixing process.

According to this configuration, since the inorganic pigment printing method of the present invention performs printing on the medium by the UV inkjet printer, thereby fixing the ultraviolet curing resin to the medium, the ultraviolet curing resin ejected to the medium is immediately hardened by ultraviolet light, whereby it is possible to suppress the ultraviolet curing resin from bleeding on the medium. Therefore, the inorganic pigment printing method of the present invention can perform printing on the medium with the inorganic pigment, without performing a pretreatment process of adhering a pretreatment agent for preventing bleeding to the medium.

Also, in the inorganic pigment printing method of the present invention, the resin fixing process may be a process of imparting adhesion to the surface of the ultraviolet curing resin fixed to the medium, and the inorganic pigment printing method may include a pigment fixing process of fixing the inorganic pigment to the ultraviolet curing resin by adhering the inorganic pigment to the ultraviolet curing resin by the adhesion of the surface of the ultraviolet curing resin fixed to the medium by the resin fixing process.

According to this configuration, since the inorganic pigment printing method of the present invention can perform printing on the medium with the ultraviolet curing resin containing no inorganic pigment by the UV inkjet printer, it can perform printing on the medium with the inorganic pigment having a particle diameter larger than a particle diameter which can be ejected by the UV inkjet printer. Also, since the inorganic pigment printing method of the present invention can perform printing on the medium with the ultraviolet curing resin containing no inorganic pigment by the UV inkjet printer, it is possible to achieve an effect in which the inorganic pigment is not deposited in the ultraviolet curing resin in the UV inkjet printer.

Also, in the inorganic pigment printing method of the present invention, the resin fixing process may be a process of ejecting the ultraviolet curing resin containing the inorganic pigment toward the medium by the UV inkjet printer, and radiating ultraviolet light onto the ejected ultraviolet curing resin, and since the ultraviolet curing resin is fixed to the medium by the resin fixing process, in the pigment fixing process, the inorganic pigment may have been fixed to the ultraviolet curing resin fixed to the medium.

According to this configuration, since the inorganic pigment printing method of the present invention performs printing on the medium with the ultraviolet curing resin containing the inorganic pigment by the UV inkjet printer, it can perform printing on the medium with the inorganic pigment, without performing a process of adhering the inorganic pigment to the ultraviolet curing resin fixed to the medium by the resin fixing process.

Also, in the inorganic pigment printing method of the present invention, the pigment fixing process may be a process of fixing the inorganic pigment to the medium by temporarily liquefying the inorganic pigment by heating and then fixing the inorganic pigment to the medium.

According to this configuration, since the inorganic pigment printing method of the present invention fixes the inorganic pigment to the medium by temporarily liquefying the inorganic pigment by heating, it can fix the inorganic pigment to the medium, without using glaze.

Also, in the inorganic pigment printing method of the present invention, the pigment fixing process maybe a process of fixing the inorganic pigment to the medium with glaze by temporarily liquefying the glaze by heating and then fixing the glaze to the medium.

According to this configuration, since the inorganic pigment printing method of the present invention fixes the inorganic pigment to the medium by temporarily liquefying the glaze by heating, it can perform printing on the medium with the inorganic pigment having a liquefaction temperature higher than that of the glaze.

Also, in the inorganic pigment printing method of the present invention, the ultraviolet curing resin may be a water-soluble ultraviolet curing resin.

According to this configuration, in the inorganic pigment printing method of the present invention, since the ultraviolet curing resin burns at a temperature lower than the melting point of media, media having low liquefaction temperatures can be used. Also, in the inorganic pigment printing method of the present invention, since the ultraviolet curing resin burns at a temperature lower than the melting point of media, long-time heating for burning the ultraviolet curing resin and long-time cooling for returning the ultraviolet curing resin to an appropriate temperature after heating are unnecessary. Therefore, it is possible to reduce the total time of processing. Also, in the inorganic pigment printing method of the present invention, since the ultraviolet curing resin burns at a temperature lower than the melting point of media, long-time heating for burning the ultraviolet curing resin is unnecessary, and thus it is possible to suppress energy consumption.

### Advantageous Effects of Invention

The inorganic pigment printing method of the present invention can perform printing on a medium with an inorganic pigment, without performing a pretreatment process of adhering a pretreatment agent for preventing bleeding to the medium.

### BRIEF DESCRIPTION OF DRAWINGS

FIG. 1 is a view illustrating a rough configuration of an UV inkjet printer which is used in an inorganic pigment printing method according to a first embodiment of the present invention.

FIG. 2 is a flow chart of the inorganic pigment printing method according to the first embodiment of the present invention.

FIG. 3 is a side view of a medium at individual time points in the inorganic pigment printing method shown in FIG. 2.

FIG. 4 is a side view of a medium in an example of a pigment fixing process of the inorganic pigment printing method of FIG. 2 which is different from the example shown in FIG. 3.

FIG. 5 is a flow chart of an inorganic pigment printing method according to a second embodiment of the present invention.

FIG. 6 is a side view of a medium at individual time points in the inorganic pigment printing method shown in FIG. 5.

### DESCRIPTION OF EMBODIMENTS

Hereinafter, embodiment of the present invention will be described with reference to drawings.

### First Embodiment

First, materials which are used in an inorganic pigment printing method according to a first embodiment of the present invention will be described.

In the inorganic pigment printing method according to the present embodiment, media, an inorganic pigment for performing printing on the media, an ultraviolet curing resin for temporarily fixing the inorganic pigment to the media, and glaze for finally fixing the inorganic pigment to the media are used.

The media are formed of an inorganic material such as a ceramic, glass, enamel, a tile, or a metal.

The ultraviolet curing resin is a resin which hardens if being irradiated with ultraviolet light. The ultraviolet curing resin is an organic material, and can be burned by heating, for example, at a temperature equal to or higher than 450° C. to 800° C. The ultraviolet curing resin which is used in the inorganic pigment printing method according to the present embodiment is so-called clear ink containing no inorganic pigment as a coloring component.

As the ultraviolet curing resin, there are water-soluble ultraviolet curing resins soluble in water, and solvent-soluble ultraviolet curing resins insoluble in water but soluble in an organic solvent. The water-soluble ultraviolet curing resins have little odor and are not quick drying, and thus can be more easily handled than the solvent-soluble ultraviolet curing resins. Also, the ultraviolet curing resin has a melting point lower than those of metal pigments, and burns at a low temperature. Further, especially in a case where media 20 are formed of glass, the ultraviolet curing resin burns at a temperature lower than a temperature between 600° C. and 800° C. which is the glass-transition temperature or melting point of the glass. Therefore, according to the present embodiment, it is possible to use media including glass as media 20.

Also, since the ultraviolet curing resin burns at a temperature lower than the melting point of media 20, the inorganic pigment printing method according to the present embodiment does not need long-time heating for burning the ultraviolet curing resin and long-time cooling for returning the ultraviolet curing resin to an appropriate temperature after heating. Therefore, it is possible to reduce the total time of processing. Also, since the ultraviolet curing resin burns at a temperature lower than the melting point of media 20, the inorganic pigment printing method according to the present embodiment does not need long-time heating for burning the ultraviolet curing resin. Therefore, it is possible to suppress energy consumption.

Therefore, it is preferable that a water-soluble ultraviolet curing resin be used as the ultraviolet curing resin which is used in the inorganic pigment printing method according to the present embodiment. As the ultraviolet curing resin which is used in the inorganic pigment printing method according to the present embodiment, an ultraviolet curing resin other than water-soluble ultraviolet curing resins may be used.

For example, as the ultraviolet curing resin which is used in the inorganic pigment printing method according to the present embodiment, an acrylamide-based compound having one vinyl group can be used. As the acrylamide-based compound having one vinyl group, (meta) acrylamide can be used, or N-substituted (meta) acrylamide can also be used. As the N-substituted (meta) acrylamide, for example, N-alkyl (meta) acrylamide having alkyl groups with a carbon number between 1 and 4, such as N-methyl (meta) acrylamide, N-ethyl (meta) acrylamide, N-propyl (meta) acrylamide, N-butyl (meta) acrylamide, N, N′-dimethyl (meta) acrylamide, or N, N′-diethyl (meta) acrylamide, N-hydroxyalkyl (meta) acrylamide having alkyl groups with a carbon number between 2 and 4, such as N-hydroxyethyl (meta) acrylamide, N-hydroxypropyl (meta) acrylamide, N-hydroxybutyl (meta) acrylamide, or the like can be used. From among them, N-hydroxyethyl (meta) acrylamide which easily becomes low viscosity and thus becomes ink for UV inkjet printers is preferable.

Now, the configuration of the UV (Ultra Violet) inkjet printer which is used in the inorganic pigment printing method according to the present embodiment will be described.

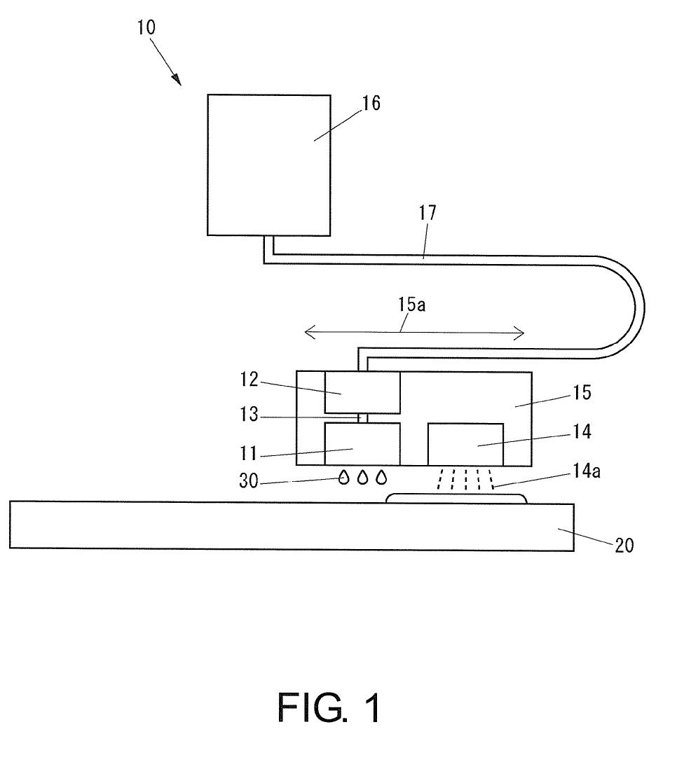

FIG. 1 is a view illustrating a rough configuration of a UV inkjet printer 10 which is used in the inorganic pigment printing method according to the present embodiment.

As shown in FIG. 1, the UV inkjet printer 10 includes an inkjet head 11 configured to eject an ultraviolet curing resin 30 toward a medium 20, a sub tank 12 configured to supply the ultraviolet curing resin 30 to the inkjet head 11, a flow passage 13 configured to connect the inkjet head 11 and the sub tank 12, an ultraviolet-light radiating device 14 for radiating ultraviolet light 14a onto the ultraviolet curing resin 30 ejected by the inkjet head 11, a carriage 15 configured to have the inkjet head 11, the sub tank 12, the flow passage 13, and the ultraviolet-light radiating device 14 and move the inkjet head 11 and the ultraviolet-light radiating device 14 in a direction shown by an arrow 15a with respect to the medium 20, a main tank 16 configured to supply the ultraviolet curing resin 30 to the sub tank 12, and a flexible flow passage 17 configured to connect the sub tank 12 and the main tank 16.

Also, the sub tank 12 is a mechanical damper configured to supply the ultraviolet curing resin 30 by a hydraulic head difference, such that the pressure of the ultraviolet curing resin 30 to be supplied to the inkjet head 11 is maintained in a predetermined range. The UV inkjet printer 10 may include a pressure damper which is a damper configured to electrically control the pressure of the ultraviolet curing resin 30 to be supplied to the inkjet head 11 in a predetermined range, using a vacuum pump, in place of the sub tank 12.

The UV inkjet printer 10 is a device configured to perform printing by ejecting the ultraviolet curing resin 30 toward a medium 20 by the inkjet head 11 and irradiating the ejected ultraviolet curing resin 30 with ultraviolet light 14a by the ultraviolet-light radiating device 14.

For some reasons such as electric power saving, long life, and low price, it is preferable that a UV-LED (Light Emitting Diode) be used as the ultraviolet-light radiating device 14. However, as the ultraviolet-light radiating device 14, a device other than UV-LEDs may be used as long as it can radiate ultraviolet light 14a having a wavelength capable of hardening the ultraviolet curing resin 30.

Now, the inorganic pigment printing method according to the present embodiment will be described.

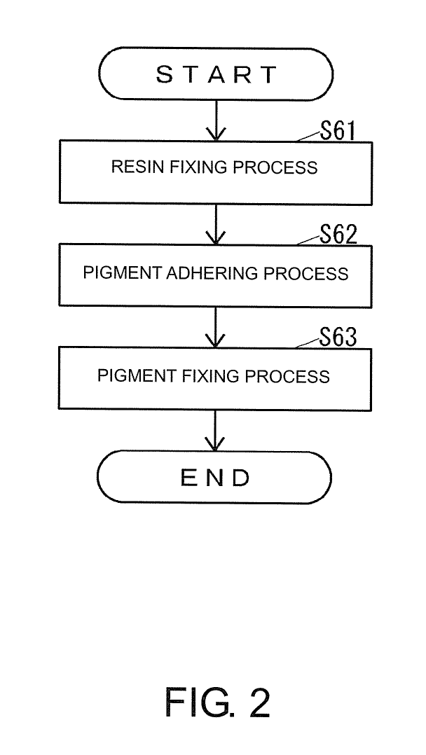

FIG. 2 is a flow chart of the inorganic pigment printing method according to the present embodiment.

As shown in FIG. 2, the inorganic pigment printing method according to the present embodiment includes a resin fixing process (S61) of fixing the ultraviolet curing resin to a medium, a pigment adhering process (S62) of adhering the inorganic pigment to the ultraviolet curing resin after the resin fixing process, and a pigment fixing process (S63) of fixing the inorganic pigment to the medium after the pigment adhering process.

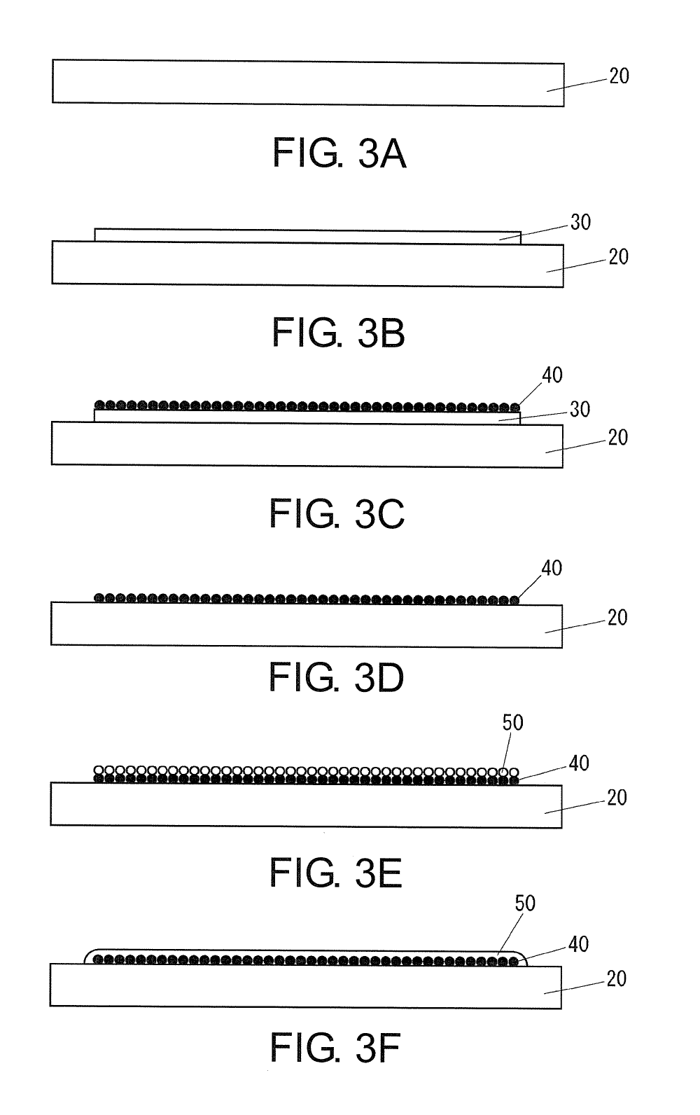

FIG. 3 is a side view of a medium 20 at individual time points in the inorganic pigment printing method according to the present embodiment.

First, the resin fixing process of S61 will be described.

In the resin fixing process of S61, first, as shown in (a) of FIG. 3, a medium 20 is prepared.

Subsequently, printing is performed on the medium 20 with the ultraviolet curing resin 30 in a shape in which printing will be finally performed on the medium 20 with the inorganic pigment, by the UV inkjet printer 10, whereby the ultraviolet curing resin 30 is fixed to the medium 20 as shown in (b) of FIG. 3.

First, the UV inkjet printer 10 moves the carriage 15 in a main scan direction which is a direction to the left of the arrow 15a as a viewer faces FIG. 1. At this time, the UV inkjet printer 10 ejects the ultraviolet curing resin 30 from the inkjet head 11 toward the medium 20. Besides, the UV inkjet printer 10 radiates ultraviolet light 14a from the ultraviolet-light radiating device 14 toward the ultraviolet curing resin 30 adhered to the surface of the medium 20. As a result, the ultraviolet curing resin 30 on the surface of the medium 20 completely hardens or semi-hardens quickly.

Therefore, the ultraviolet curing resin 30 adhered to the medium 20 completely hardens or semi-hardens without bleeding. The UV inkjet printer 10 keeps performing this operation until the carriage 15 reaches an end in the main scan direction.

Subsequently, the UV inkjet printer 10 moves the carriage 15 in the reverse direction of the main scan direction which is a direction to the right of the arrow 15a as a viewer faces FIG. 1. At this time, the UV inkjet printer 10 does not eject the ultraviolet curing resin 30 from the inkjet head 11 toward the medium 20 and does not radiate ultraviolet light 14a from the ultraviolet-light radiating device 14.

In the resin fixing process of S61, adhesion is imparted to the surface of the ultraviolet curing resin 30 fixed to the medium 20. As a method of imparting adhesion to the surface of the ultraviolet curing resin 30 fixed to the medium 20, for example, a method of imparting adhesion to the surface of the ultraviolet curing resin 30 fixed to the medium by making the ultraviolet curing resin 30 fixed to the medium 20 an incompletely hardened state, that is, a temporarily hardened (semi-hardened) state, or a method of using an ultraviolet curing resin 30 whose surface is adherable when the ultraviolet curing resin is in a so-called completely-hardened state can be used. Also, as the method of making the ultraviolet curing resin 30 fixed to the medium 20 the temporarily hardened (semi-hardened) state, for example, a method of reducing at least one of radiation intensity and radiation time in a case of radiating ultraviolet light 14a toward the ultraviolet curing resin 30 by the ultraviolet-light radiating device 14 as compared to a case of completely hardening the ultraviolet curing resin 30 fixed to the medium 20 can be used.

Now, the pigment adhering process of S62 will be described.

In the pigment adhering process of S62, as shown in (c) of FIG. 3, powder of an inorganic pigment 40 is dispersed on the ultraviolet curing resin 30 fixed to the medium 20, whereby the inorganic pigment 40 is adhered to the ultraviolet curing resin 30 by the adhesion of the surface of the ultraviolet curing resin 30.

In S61, since the ultraviolet curing resin 30 is in the semi-hardened state, its surface is adherable. Therefore, if powder of the inorganic pigment 40 is dispersed, the inorganic pigment 40 adheres to only parts of the surface of the medium 20 where there is the ultraviolet curing resin 30, whereby an image is formed by the inorganic pigment 40.

Now, the pigment fixing process of S63 will be described.

In the pigment fixing process of S63, first, heating is performed, for example, at 450° C. to 600° C., such that the ultraviolet curing resin 30 is removed as shown in (d) of FIG. 3 by burning. The ultraviolet curing resin 30 is composed of carbon, hydrogen, and nitrogen. Therefore, if the ultraviolet curing resin 30 burns, carbon dioxide, water vapor, and nitrogen dioxide are produced and vaporize. Meanwhile, the degree of adhesion of the inorganic pigment 40 adhered to the surface of the ultraviolet curing resin 30 to the medium 20 improves if the ultraviolet curing resin 30 is removed by burning. Therefore, the inorganic pigment 40 does not easily flow even if glaze 50 is applied.

Subsequently, as shown in (e) of FIG. 3, the glaze 50 is applied.

Finally, the glaze 50 is temporarily liquefied by heating, for example, at about 600° C., and then is solidified by cooling, thereby being fixed to the medium 20. Therefore, as shown in (f) of FIG. 3, the inorganic pigment 40 is fixed to the medium 20 by the glaze 50.

As described above, the inorganic pigment printing method according to the present embodiment performs printing on a medium 20 by the UV inkjet printer 10, thereby fixing the ultraviolet curing resin 30 to the medium 20 by ultraviolet light 14a. Therefore, the ultraviolet curing resin 30 ejected to the medium 20 is immediately hardened by ultraviolet light 14a, whereby it is possible to suppress the ultraviolet curing resin 30 from bleeding on the medium 20. The inorganic pigment printing method according to the present embodiment can perform printing on a medium 20 with the inorganic pigment 40, without performing a pretreatment process of adhering a pretreatment agent for preventing bleeding to the medium 20.

The inorganic pigment printing method according to the present embodiment does not need to perform a pretreatment process, and thus can reduce the total time of processing as compared to a method which needs to perform a pretreatment process.

Since the inorganic pigment printing method according to the present embodiment does not need to perform a pretreatment process, it can reduce the cost by the cost of a pretreatment agent to be used in a pretreatment process.

Since the inorganic pigment printing method according to the present embodiment can suppress the ultraviolet curing resin 30 from bleeding on media 20, it can perform highly accurate printing on media 20 with the inorganic pigment 40.

Since the inorganic pigment printing method according to the present embodiment can perform printing on media 20 with the ultraviolet curing resin 30 containing no inorganic pigment 40 by the UV inkjet printer 10, it is possible to perform printing on media 20 with the inorganic pigment 40 having a particle diameter larger than a particle diameter which can be ejected by the UV inkjet printer 10.

Here, the particle diameter which can be ejected by the UV inkjet printer 10 is determined on the basis of the diameter of nozzles (not shown in the drawings) of the inkjet head 11 for ejecting the ultraviolet curing resin 30. The reason is that, if the particle diameter of the inorganic pigment 40 is larger than the diameter of the nozzles, the nozzles are clogged. Also, in general, the particle diameter of the inorganic pigment 40 is not easily reduced.

However, in contrast, in order to form an image on a medium. 20, it is not necessary to reduce the particle diameter of the inorganic pigment 40 to the diameter of the nozzles. The reason is that, in general, even though a portion of an image which is formed on a medium 20 is the thinnest, the thickness of that portion is greater than the diameter of the nozzles.

In the present embodiment, the ultraviolet curing resin 30 is ejected to a medium 20, and is irradiated with ultraviolet light 14a, thereby being semi-hardened, and then the inorganic pigment 40 is adhered to the semi-hardened ultraviolet curing resin 30. Therefore, the inorganic pigment printing method according to the present embodiment does not need to make the particle diameter of the inorganic pigment 40 smaller than the diameter of the nozzles, and thus can be more easily realized as compared to a method of performing printing on a medium 20 with the ultraviolet curing resin 30 containing the inorganic pigment 40 by the UV inkjet printer 10.

Since the inorganic pigment printing method according to the present embodiment can perform printing on media 20 with the ultraviolet curing resin 30 containing no inorganic pigment 40 by the UV inkjet printer 10, it is possible to achieve an effect in which the inorganic pigment 40 is not deposited in the ultraviolet curing resin 30 in the UV inkjet printer 10. Also, if the inorganic pigment 40 is deposited in the ultraviolet curing resin 30 in the UV inkjet printer 10, various problems occur. For example, a problem in which the concentration of the inorganic pigment 40 in the ultraviolet curing resin 30 ejected from the inkjet head 11 becomes lower than a predetermined concentration occurs. Also, a problem in which passages for the ultraviolet curing resin 30 in the UV inkjet printer 10 are clogged with the deposited inorganic pigment 40, whereby the ultraviolet curing resin 30 and the inorganic pigment 40 are not appropriately ejected from the inkjet head 11 occurs.

Since the inorganic pigment 40 is not deposited in the ultraviolet curing resin 30 in the UV inkjet printer 10, the inorganic pigment printing method according to the present embodiment can perform printing on media 20 with the inorganic pigment 40 having a higher specific gravity, such as a metal, as compared to the method of performing printing on media 20 with the ultraviolet curing resin 30 containing the inorganic pigment 40 by the UV inkjet printer 10.

Also, in the inorganic pigment printing method according to the present embodiment, since the inorganic pigment 40 is not deposited in the ultraviolet curing resin 30 in the UV inkjet printer 10, in order to prevent the inorganic pigment 40 from being deposited in places in the UV inkjet printer 10 where there is the ultraviolet curing resin 30, such as the inkjet head 11, the sub tank 12, the flow passage 13, the main tank 16, and the flow passage 17, the UV inkjet printer 10 does not need to have devices for stirring the inorganic pigment 40 by circulating the inorganic pigment in those places.

Since the inorganic pigment printing method according to the present embodiment temporarily liquefies the glaze 50 by heating, thereby fixing the inorganic pigment 40 to media 20, it performs printing on media 20 with the inorganic pigment 40 having a liquefaction temperature higher than that of the glaze 50.

Also, in the above description, in the pigment fixing process of S63, the glaze 50 is applied; however, the glaze 50 may be applied in the pigment adhering process of S62. In this case, the inorganic pigment 40 burns at a temperature lower than the glass-transition temperature of the glaze 50. Also, in general, the glaze 50 is dried and then is heated. Therefore, since the inorganic pigment 40 is fixed to a medium 20 by burning, and then the glaze 50 undergoes a glass transition, an image formed by the inorganic pigment 40 is not distorted.

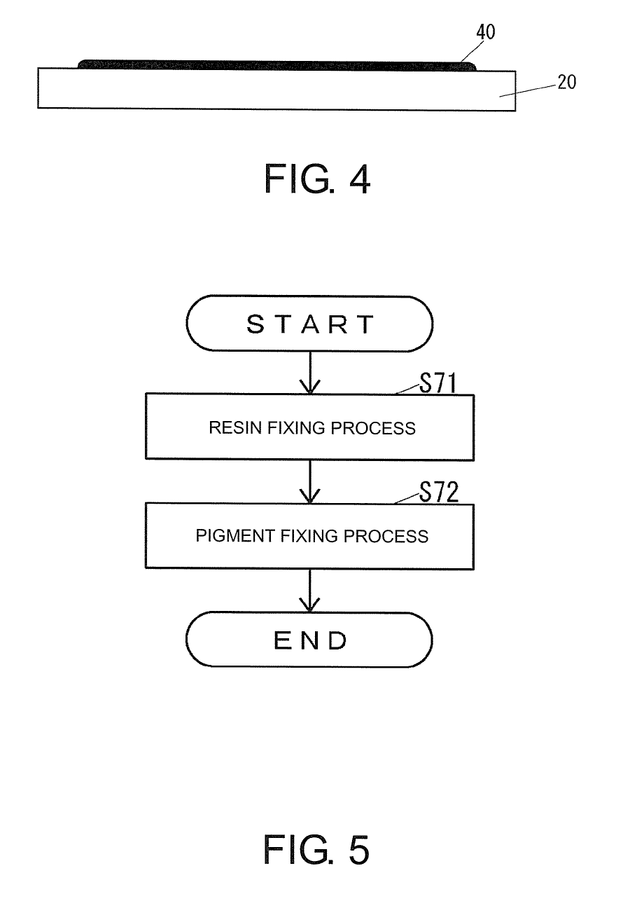

Also, the pigment fixing process of S63 is a process of temporarily liquefying the glaze 50 by heating, and then re-solidifying the glaze by cooling, thereby fixing the inorganic pigment 40 to a medium 20; however, it may be a process of temporarily liquefying the inorganic pigment 40 by heating, and then re-solidifying the inorganic pigment by cooling, thereby fixing the inorganic pigment 40 to a medium 20 as shown in FIG. 4. In the case of temporarily liquefying the inorganic pigment 40 by heating, thereby fixing the inorganic pigment 40 to a medium 20, the inorganic pigment printing method according to the present embodiment can fix the inorganic pigment 40 to the medium 20 without using the glaze 50.

### Second Embodiment

First, materials which are used in an inorganic pigment printing method according to a second embodiment of the present invention will be described.

The materials which are used in the inorganic pigment printing method according to the present embodiment are basically identical to the materials which are used in the inorganic pigment printing method according to the first embodiment.

However, in the inorganic pigment printing method according to the present embodiment, the ultraviolet curing resin contains powder of the inorganic pigment 40. In other words, in the inorganic pigment printing method according to the present embodiment, so-called UV color ink obtained by mixing powder of the inorganic pigment 40 as a coloring component with the ultraviolet curing resin is used. The UV color ink contains, for example, the water-soluble ultraviolet curing resin 30, the inorganic pigment 40, water, a specific gravity adjuster, and a surfactant. The specific gravity adjuster and the surfactant suppress deposition of the inorganic pigment 40, and promote dispersion of the inorganic pigment.

Now, the inorganic pigment printing method according to the present embodiment will be described.

FIG. 5 is a flow chart of the inorganic pigment printing method according to the present embodiment.

As shown in FIG. 5, the inorganic pigment printing method according to the present embodiment includes a resin fixing process (S71) of fixing the ultraviolet curing resin 30 to a medium, and a pigment fixing process (S72) of fixing the inorganic pigment 40 to the medium after the resin fixing process.

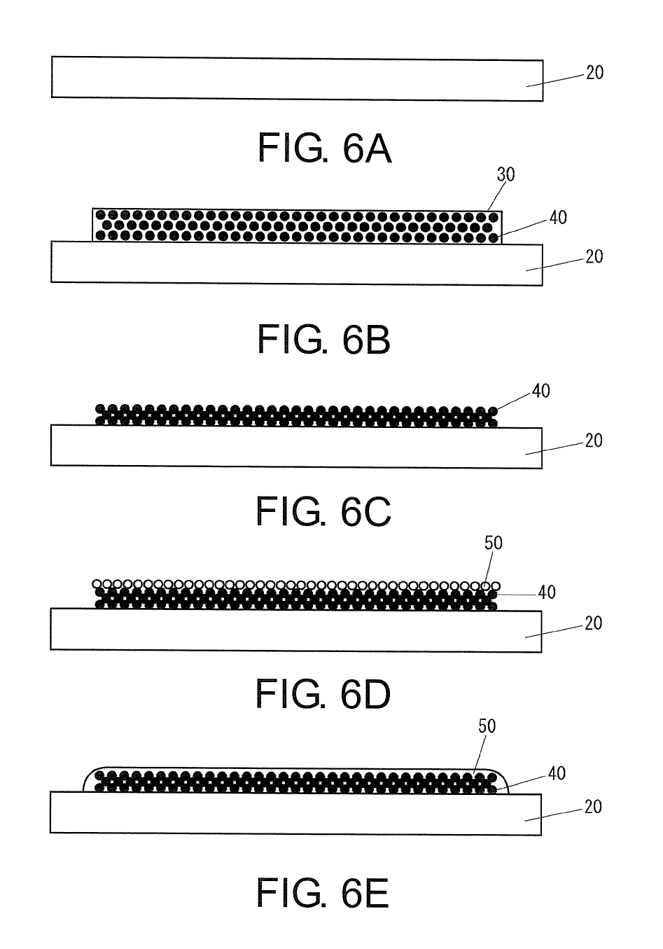

FIG. 6 is a side view of a medium 20 at individual time points in the inorganic pigment printing method according to the present embodiment.

First, the resin fixing process of S71 will be described.

In the resin fixing process of S71, first, as shown in (a) of FIG. 6, a medium 20 is prepared.

Subsequently, printing is performed on the medium 20 with the ultraviolet curing resin 30 in a shape in which printing will be finally performed on the medium 20 with the inorganic pigment 40, by the UV inkjet printer 10, whereby the ultraviolet curing resin 30 is fixed to the medium 20 as shown in (b) of FIG. 6.

In the inorganic pigment printing method according to the present embodiment, since the ultraviolet curing resin 30 contains powder of the inorganic pigment 40, at a stage after the resin fixing process of S71, the inorganic pigment 40 has been fixed to the ultraviolet curing resin 30 fixed to the medium 20.

Now, the pigment fixing process of S72 will be described.

In the pigment fixing process of S72, first, for example, heating is performed, for example, at 450° C. to 600° C., such that the ultraviolet curing resin 40 is removed as shown in (c) of FIG. 6 by burning.

Subsequently, as shown in (d) of FIG. 6, the glaze 50 is applied.

Finally, the glaze 50 is temporarily liquefied by heating, for example, at about 600° C., and then is re-solidified by cooling, thereby being fixed to the medium 20. Therefore, as shown in (e) of FIG. 6, the inorganic pigment 40 is fixed to the medium 20 by the glaze 50.

As described above, the inorganic pigment printing method according to the present embodiment performs printing on media 20 by the UV inkjet printer 10, thereby fixing the ultraviolet curing resin 30 to the media 20. Therefore, the ultraviolet curing resin 30 ejected to the media 20 is immediately hardened by ultraviolet light 14a, whereby it is possible to suppress the ultraviolet curing resin 30 from bleeding on the media 20. Therefore, the inorganic pigment printing method according to the present embodiment can perform printing on media 20 with the inorganic pigment 40, without performing a pretreatment process of adhering a pretreatment agent for preventing bleeding to the media 20.

Since the inorganic pigment printing method according to the present embodiment performs printing on a medium 20 with the ultraviolet curing resin 30 containing the inorganic pigment 40 by the UV inkjet printer 10, it can perform printing on a medium 20 with the inorganic pigment 40, without performing the process (S62) of adhering the inorganic pigment 40 to the ultraviolet curing resin 30 fixed to the medium 20 by the resin fixing process of S71.

Since the inorganic pigment printing method according to the present embodiment fixes the inorganic pigment 40 to a medium 20 by temporarily liquefying the glaze 50 by heating, it can perform printing on a medium 20 with the inorganic pigment 40 having a liquefaction temperature higher than that of the glaze 50.

Also, the pigment fixing process of S72 is a process of temporarily liquefying the glaze 50 by heating, and then re-solidifying the glaze by cooling, thereby fixing the inorganic pigment 40 to a medium 20; however, it may be a process of temporarily liquefying the inorganic pigment 40 by heating, and then re-solidifying the inorganic pigment by cooling, thereby fixing the inorganic pigment 40 to a medium 20. In the case of temporarily liquefying the inorganic pigment 40 by heating, thereby fixing the inorganic pigment 40 to a medium 20, the inorganic pigment printing method according to the present embodiment can fix the inorganic pigment 40 to the medium 20 without using the glaze 50.

### REFERENCE SIGNS LIST

10: UV inkjet printer

20: medium

30: ultraviolet curing resin

40: inorganic pigment

50: glaze

1. An inorganic pigment printing method of performing printing on a medium with an inorganic pigment, comprising:
a resin fixing process of fixing an ultraviolet curing resin curable by being irradiated with ultraviolet light, to the medium, by a UV inkjet printer configured to eject the ultraviolet curing resin and radiate ultraviolet light onto the ejected ultraviolet curing resin; and
a pigment fixing process of fixing the inorganic pigment to the medium while removing the ultraviolet curing resin by burning in a state where the inorganic pigment has been fixed to the ultraviolet curing resin that is fixed to the medium by the resin fixing process.

2. The inorganic pigment printing method according to claim 1, wherein:
the resin fixing process is a process of imparting adhesion to a surface of the ultraviolet curing resin fixed to the medium, and
the inorganic pigment printing method includes a pigment fixing process of fixing the inorganic pigment to the ultraviolet curing resin by adhering the inorganic pigment to the ultraviolet curing resin by the adhesion of the surface of the ultraviolet curing resin fixed to the medium by the resin fixing process.

3. The inorganic pigment printing method according to claim 1, wherein:
the resin fixing process is a process of ejecting the ultraviolet curing resin containing the inorganic pigment toward the medium by the UV inkjet printer, and radiating ultraviolet light onto the ejected ultraviolet curing resin, and
since the ultraviolet curing resin is fixed to the medium by the resin fixing process, in the pigment fixing process, the inorganic pigment is fixed to the ultraviolet curing resin that is fixed to the medium.

4. The inorganic pigment printing method according to claim 1, wherein:
the pigment fixing process is a process of fixing the inorganic pigment to the medium by temporarily liquefying the inorganic pigment by heating and then fixing the inorganic pigment to the medium.

5. The inorganic pigment printing method according to claim 1, wherein:
the pigment fixing process is a process of fixing the inorganic pigment to the medium with glaze by temporarily liquefying the glaze by heating and then fixing the glaze to the medium.

6. The inorganic pigment printing method according to claim 1, wherein:
the ultraviolet curing resin is a water-soluble ultraviolet curing resin.

7. The inorganic pigment printing method according to claim 2, wherein:
the pigment fixing process is a process of fixing the inorganic pigment to the medium by temporarily liquefying the inorganic pigment by heating and then fixing the inorganic pigment to the medium.

8. The inorganic pigment printing method according to claim 3, wherein:
the pigment fixing process is a process of fixing the inorganic pigment to the medium by temporarily liquefying the inorganic pigment by heating and then fixing the inorganic pigment to the medium.

9. The inorganic pigment printing method according to claim 2, wherein:
the pigment fixing process is a process of fixing the inorganic pigment to the medium with glaze by temporarily liquefying the glaze by heating and then fixing the glaze to the medium.

10. The inorganic pigment printing method according to claim 3, wherein:
the pigment fixing process is a process of fixing the inorganic pigment to the medium with glaze by temporarily liquefying the glaze by heating and then fixing the glaze to the medium.
